(19) United States
(12) Patent Application Publication
(10) Pub. No.: US 2015/0185020 A1
(43) Pub. Date: Jul. 2, 2015

(54) COMPATIBILITY BASED RESOURCE MATCHING

(71) Applicant: International Business Machines Corporation, Armonk, NY (US)

(72) Inventors: David J. Gimpl, Rochester, MN (US); Pei Ming Hu, Shanghai (CN); Nedzad Taljanovic, Tucson, AZ (US)

(73) Assignee: International Business Machines Corporation, Armonk, NY (US)

(21) Appl. No.: 14/280,937

(22) Filed: May 19, 2014

Related U.S. Application Data
(63) Continuation of application No. 14/143,131, filed on Dec. 30, 2013.

(51) Int. Cl. G01C 21/20

(52) U.S. Cl. CPC G01C 21/20

(57) ABSTRACT

According to embodiments of the invention, methods and a computer system for compatibility based resource matching are disclosed. The method may include receiving route requirements from a plurality of users determining whether the route requirements for a first of the plurality of users are trip compatible with a second of the plurality of users; and determining a ridesharing route for the first and second users in response to determining the route requirements are trip compatible. The trip compatibility may be determined based on route requirements such as a starting point, a destination point, a driver or rider preference, an arrival window, a destination window, and fee rate.

### BACKGROUND

The present disclosure relates to the field of routing. More specifically, the present disclosure relates to a method of creating routes based on compatibility determinations between users.

As communities grow in size the number of vehicles using roads for transportation has increased. Along with the increased demand for space on the road, fuel prices have increased which may increase the cost of transportation by vehicle. As the demand for road space and the cost of transportation have increased, the need to share vehicles and to share costs has also increased.

### SUMMARY

A method of ridesharing may include receiving route requirements from a plurality of users, determining whether the route requirements for a first of the plurality of users are trip compatible with a second of the plurality of users, and determining a ridesharing route for the first and second users in response to determining the route requirements are trip compatible. The route requirements for each of the plurality of users may include a starting point, a destination point, a driver or rider preference, an arrival window, a destination window, and fee rate.

Determining whether the route requirements are trip compatible may include determining a first compatibility route and a second compatibility route based on the starting point and the destination point for the first and second users. Determining whether the route requirements are trip compatible may include determining a first linking connection from the first compatibility route to the second compatibility route, calculating a linking distance of the first linking connection, and determining the route requirements are trip compatible in response to the linking distance being less than or equal to a preferred linking distance.

The first user may have a first starting point and first destination and the second user may have a second starting point and second destination point. The first compatibility route may be a drivable path from the first starting point to the first destination point and the second compatibility route is a drivable path from the second starting point to the second destination point. The method may further include determining a second linking connection, wherein the first linking connection is a path from the first compatibility route to the second starting point and the second linking connection is a path from the second compatibility route to the first compatibility route. The linking distance may be further based the second linking connection.

The first linking connection may be a straight line from the first compatibility route to the second compatibility route. Determining that the route requirements are trip compatible may include determining whether the departure window for the first and second user overlap and whether the arrival window for the first and second user overlap. And may also include determining the route requirements are trip compatible in response to determining that the departure windows overlap and that the arrival windows overlap. Determining whether the route requirements are trip compatible may include determining at least one driver and at least one rider based on the driver or rider preference. And may also include determining the route requirements are trip compatible in response to the fee rate for the at least one driver being less than or equal to the fee rate for the at least one rider.

The method may include determining a ridesharing cost of the ridesharing route, and presenting the ridesharing cost to the plurality of users. The ridesharing cost may be based on an estimated travel time between the each of the starting points and destination points. The ridesharing cost may also be based on a prorated financial cost of traveling the ridesharing route. The method may further include receiving acceptance of the ridesharing route from the at least one driver and the at least one rider.

A method of ridesharing may include receiving route requirements from a plurality of users, the route requirements for each of the plurality of users including a starting point, a destination point, a driver or rider preference, an arrival window, a destination window, and fee rate. The method may also include determining whether the route requirements are trip compatible and determining, in response to determining the route requirements are trip compatible, a ridesharing route from an origin to a destination reaching the starting point and the destination point for each of the plurality of users.

The method may further include calculating a weighted cost of a drivable route between each of the starting points and destination points. The ridesharing route may path to each starting point and destination point having the least weighted cost from the previous starting point and destination point which has not already been reached. The weighted cost may be based on an estimated travel time between each of the starting points and destination points.

A ridesharing system may include a user interface device, storage, and a logic device. The user interface device may be configured to receive route requirements from a plurality of users and to present information to the plurality of users. The storage may be configured to store the route requirements. The routing device may be configured to receive the route requirements from the storage and to determine to determine a ridesharing route on command. The logic device may be configured to determine whether the route requirements are trip compatible, and configured to command the routing device to determine the ridesharing route in response to the determining that the route requirements are trip compatible.

The logic device may also be configured to determine a first compatibility route and a second compatibility route based on the starting point and the destination point for the first and second users. The logic device may be configured to determine a first linking connection from the first compatibility route to the second compatibility route, to calculate a linking distance of the first linking connection, and to determine the route requirements are trip compatible in response to the linking distance being less than or equal to a preferred linking distance.

The logic device may further be configured to determine whether the departure window for the first and second user overlap and determining whether the arrival window for the first and second user overlap, and to determine the route requirements are trip compatible in response to determining that the departure windows overlap and that the arrival windows overlap. The logic device may be configured to determine at least one driver and at least one rider based on the driver or rider preference, and to determine the route requirements are trip compatible in response to the fee rate for the at least one driver being less than or equal to the fee rate for the at least one rider. Finally, the logic device may also be configured to determine a ridesharing cost of the ridesharing route. The user interface device may be configured to present the ridesharing cost to the plurality of users and receive acceptance of the ridesharing route from the at least one driver and the at least one rider.

### BRIEF DESCRIPTION OF THE DRAWINGS

FIG. 1 depicts a flow diagram of an embodiment of a method of ridesharing using route requirements to determine trip compatibility.

FIG. 2 depicts a flow diagram of an embodiment of a method of ridesharing using weighted costs to determine a ridesharing route.

FIG. 3 depicts an image of various paths between geographic user inputs including a ridesharing route.

FIG. 4 depicts an image of a system for ridesharing having a server and user interface devices.

### DETAILED DESCRIPTION

In the following description, reference is made to the accompanying drawings which, by way of illustration, include various examples by which the disclosure may be used. Other examples of the disclosure may be used, as structural and operational changes may be made without departing from the scope of the present disclosure.

While the same nomenclature and same numbers may be used to identify elements throughout the disclosure, this practice is not intended to limit the scope of the disclosure. Identified elements in one figure may not be identical to other same named or identified elements in other figures.

The present disclosure relates to a ridesharing method and system. Specifically, the disclosure relates to a ridesharing system which may identify multiple users, determine trip compatible users, and create a ridesharing route between the trip compatible users.

Efficient ridesharing planning may be implemented by a system which first identifies trip compatible users and then determines a ridesharing route between the trip compatible users. Initially identifying trip compatible users with which ridesharing routes are subsequently determined may decrease the difficulty and time needed to plan a successful ridesharing route. For example, where there are hundreds of users with origins and destinations, a large amount of possible ridesharing routes between the users may exist. By identifying trip compatible users, the number of possible ridesharing routes which may be determined by the system may decrease. “Trip compatible users” are users who have similar time windows for departure and arrival, have similar riding preferences, are geographically close, save financial costs with ridesharing, and have geographically similar routes. In addition, it is contemplated that parcels may be organized and shipped in lieu of or in addition to users, using the same or substantially similar subject matter as disclosed. A “ridesharing route” is a drivable route from an origin to a destination which a rider and a driver may share.

Identifying trip compatible users may increase the chance that the users may accept the ridesharing route. The system may have access to user information, may match users together, create ridesharing routes, calculate costs, submit and receive ridesharing agreements, and receive route requirements regarding performance. User information may include various types of information which may generally involve preferences or requirements of the user for matching a user with a ridesharing route. These preferences may include, but are not limited to, geographic information, driving/riding preferences, time windows, and cost limits. The system may identify trip compatible users and create ridesharing routes based upon that information.

A method of ridesharing may include receiving route requirements from a plurality of users, determining whether the route requirements for a first of the plurality of users are trip compatible with a second of the plurality of users, and determining a ridesharing route for the first and second users in response to determining the route requirements are trip compatible.

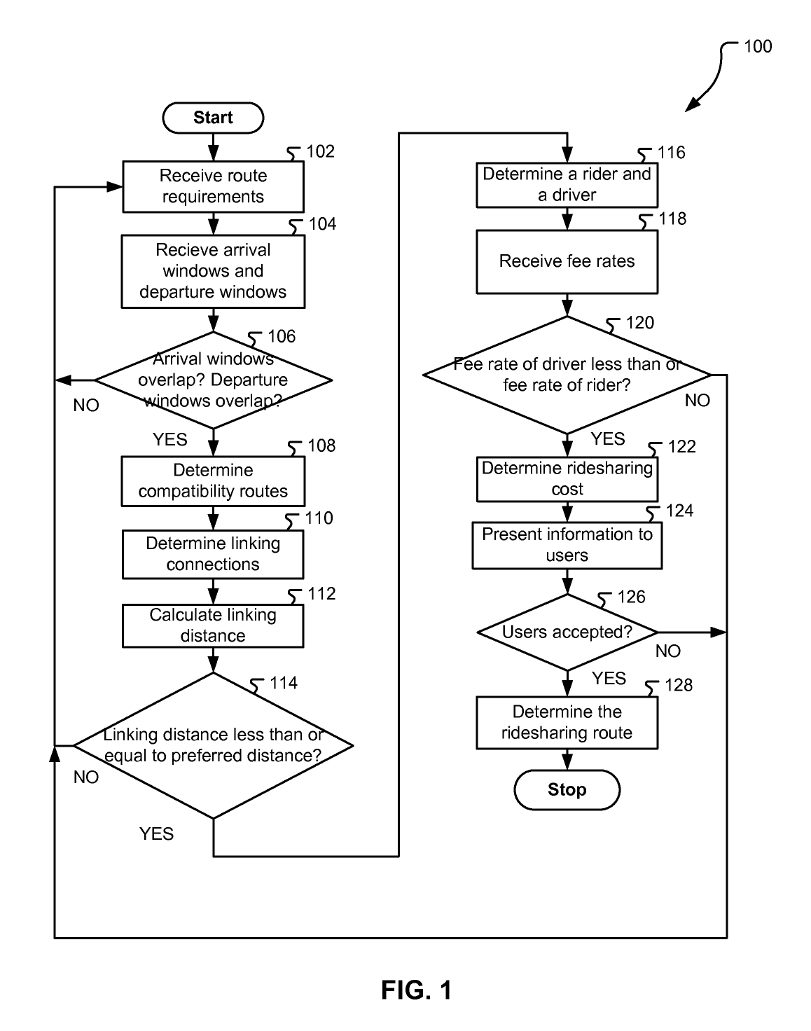

Referring now to FIG. 1, an embodiment of a method 100 of facilitating ridesharing may be seen. In operation 102, route requirements may be received. Route requirements may include a starting point, a destination point, a driver or rider preference, an arrival window, a destination window, a fee rate, or other user preferences. Route requirements may be received via a user interface device. The user interface device may include user output devices (such as a video display device, speaker, or television set) and user input devices (such as a keyboard, mouse, keypad, touchpad, trackball, buttons, light pen, or other pointing device). The user interface device may also have a user interface which may translate route requirements into commands which control a ridesharing system, described further below.

The starting point and the destination point may be entered as addresses, street numbers, and geographic locations. The starting point and the destination point may be a subset of geographical user inputs that a user may select. The geographical user inputs may be used for a variety of functions. In an embodiment, the geographical user inputs may determine where a user's origin and destination are located. The geographical user inputs may be used to determine trip compatible users for determining a ridesharing route. For example, two users with geographical user inputs which are substantially similar may be more likely to be trip compatible for ridesharing. The more similar the geographical user inputs the smaller the variation may be to accommodate transporting both users in a common vehicle.

In an embodiment having a first and second user of a plurality of users, the first user may have a first starting point and first destination point and a second user may have a may have a second starting point and a second destination point. The starting points may indicate where a user may potentially join the ridesharing route and the destination points may indicate where a user may leave the route. The location of the starting point and destination point for each user on the ridesharing route may vary, and may depend upon the starting and destination points of users, the geographical user inputs of a driver, the ridesharing route, or other factors.

In operation 104, arrival window and departure windows may be received. The arrival window and departure window may be received as a part of the route requirements in operation 102. The route requirements may be determined trip compatible based on determining whether the departure window for the first and second user overlap and determining whether the arrival window for the first and second user overlap. The departure window and the arrival window may indicate a range of time for which the user may join and leave a ridesharing route. For example, a departure window may be a range of time from 6:00 am to 6:30 am, which would indicate that acceptable ridesharing routes would reach the user's starting point within that departure window. The departure window and the arrival window may allow users flexibility to account for variables in the implementation of the ridesharing route including traffic, user lateness, or other events. In decision block 106, if the arrival windows and departure windows overlap the users corresponding to those route requirements may be determined to be trip compatible and the method may progress to operation 108. If the arrival windows and departure windows do not overlap, the method may reset back to operation 102.

In operation 108, a first compatibility route and a second compatibility route may be determined. The “compatibility route” is a drivable path from the starting point to the destination point. The first compatibility route may be a drivable path from the first starting point to the first destination point and the second compatibility route may be a drivable path from the second starting point to the second destination point. A compatibility route may be calculated for each user to filter out users who may not be trip compatible for a ridesharing route. The first compatibility route and second compatibility route may be calculated from the starting points and destination points entered in operation 102 or from other sources. The first and second compatibility routes may be calculated by geographic systems including global positioning satellite (GPS) systems, geographic information systems (GIS), or other types of geographic systems which may integrate, analyze, and display geographic information. The first and second compatibility route may be the typical GPS determined solo route from the starting point to the destination point. Three compatibility paths or more may also be calculated depending upon the number of users.

In operation 110, linking connections may be determined. The “linking connections” are various types of paths between the first and second compatibility routes. Linking connections may be used with the compatibility routes to determine whether geographic user inputs are trip compatible for ridesharing, described further below. A first linking connection may be determined as a path from the first compatibility route to the second compatibility route. In an embodiment, the linking connection may be a drivable path from the first compatibility route to the second compatibility route. Alternatively the linking connection may be a straight line from the first compatibility route to the second compatibility route.

Multiple linking connections may be calculated. For example, a first linking connection and a second linking connection may be calculated. The first linking connection may be a path from the first compatibility route to the second starting point. The second linking connection may be a path from the second destination point to the first compatibility route. The first and second linking connections may connect to the first and second compatibility routes at linking points. The linking connections may be positioned connecting various points along the first and second compatibility routes. In an embodiment, the linking connection may be positioned such that the linking connection forms the shortest path between the first and second compatibility routes. The linking connections may be used in conjunction with operation 108 to calculate a linking distance, further described below.

In operation 112, a linking distance may be calculated. The “linking distance” is a numerical representation of the geographical distance between the compatibility routes. As described above, the compatibility route may be the typical GPS determined solo route for a user. The linking distance may represent the distance of deviating from that solo route to pick up and drop off other users. The greater the similarity of geographic user inputs and the compatibility routes the lower the linking distance. The linking distance may be based on the linking connections between the compatibility routes. In an embodiment, the linking distance may be determined as the average length of the first and second linking connections.

If the linking distance is less than or equal to the preferred linking distance then, in decision block 114, the method 100 may progress to operation 116. The linking distance may be compared with the preferred linking distance to indicate whether the geographic user inputs for each user are trip compatible for a ridesharing route. The preferred linking distance may be a maximum distance which when is exceeded by the linking distance indicates that the compatibility routes are not trip compatible. In an embodiment, the preferred cost indicates a maximum distance between compatibility routes beyond which the compatibility routes are not trip compatible for ridesharing. If the linking distance is greater than the preferred linking distance then, in decision block 114, the method 100 may reset to operation 102 and new route requirements may be received.

In operation 116 a driver and a rider from among the plurality of users may be determined. The rider and the driver may be determined from the driver or rider preference. In an embodiment, the rider and driver may determine whether the route requirements are trip compatible. The driver and rider may be determined from the route requirements. In an embodiment, the plurality of users enters into a ridesharing system a preference of whether the user would like to be a rider or driver. In another embodiment, there must be at least one driver and at least one rider in order to have trip compatibility.

In operation 118, a fee rate may be determined. The “fee rate” is a numerical representation of an acceptable financial cost of a ridesharing route. The fee rate may be received from the route requirements. In an embodiment, the fee rate may determine whether the route requirements are trip compatible. In an embodiment, the plurality of users enters into a ridesharing system the fee rate. The route requirements may be trip compatible in response to the fee rate for the at least one driver being less than or equal to the fee rate for the at least one rider. In decision block 120, if the fee rate of the driver is less than or equal to the fee rate of the rider then the method 100 may progress to operation 122. If the fee rate of the driver is greater than the fee rate of the rider then the method 100 may reset to operation 102.

In operation 122, the ridesharing cost may be calculated. The ridesharing cost may include the time, financial cost, insurance cost, fare costs, of using the ridesharing route. In an embodiment, a ridesharing cost may be based on the prorated financial cost for each user traveling the ridesharing route. In operation 124 ridesharing information may be presented to the users. The ridesharing information may be presented by a user interface, through various types of user interface device which may include user output devices such as a video display device, speaker or other devices. The ridesharing information may include the ridesharing route, the estimated travel time between each of the geographical user inputs in the ridesharing route, rideshare cost, contractual obligations, or other information.

In decision block 126, a user may be prompted to accept the ridesharing information. For example, the user may be prompted to accept a contractual agreement to participate in the ridesharing route. If the user accepts the information then, in decision block 126, the method 100 may be completed. If the user does not accept the ridesharing information then the method 100 may reset to operation 102 and new route requirements may be received.

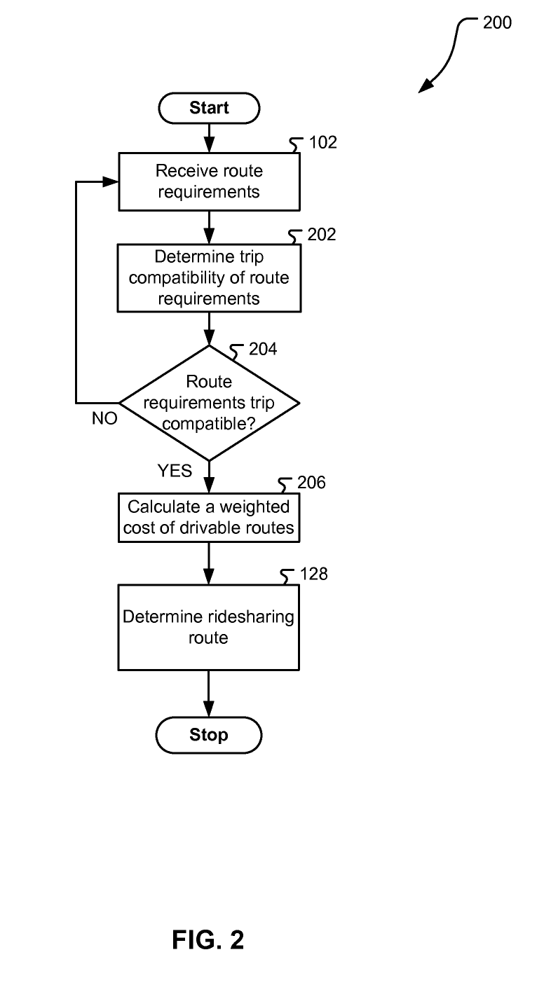

In operation 128, the ridesharing route may be determined using various methods which are further described with respect to FIG. 2. In an embodiment, the ridesharing route may be determined by calculating a weighted cost of a drivable route between each of the geographical user inputs. The ridesharing route may start from the first starting point and reach each geographical user input having a least weighted cost from the previous geographical user input which has not already been reached.

Referring now to FIG. 2, an embodiment of a method 200 of ridesharing may include receiving route requirements including geographical user inputs including a first starting point, a first destination point, a second starting point and a second destination point. The method 200 may include determining a first compatibility route and a second compatibility route based on the geographic user inputs, and determining a first linking connection from the first compatibility route to the second compatibility route. The method 200 also may include calculating a linking distance of the first linking connection determining, in response to the linking distance being less than or equal to a preferred linking distance, a ridesharing route from an origin to a destination reaching each of the geographical user inputs determining a ridesharing cost of the ridesharing route and presenting the ridesharing cost to a user.

In operation 102, route requirements may be received. Route requirements may include a starting point, a destination point, a driver or rider preference, an arrival window, a destination window, and fee rate. The route requirements may be the same or substantially similar as described above. In operation 202, the trip compatibility of the route requirements may be determined. The trip compatibility may be determined in the same or substantially similar manner as described above with reference to FIG. 1. If the linking route requirements are trip compatible then, in decision block 204, the method 200 may progress to operation 206 and a weighted cost of drivable routes may be calculated. If the linking distance is greater than the preferred cost then, in decision block 110, the method 100 may reset to operation 102 and new route requirements may be received. Decision block 110 may be the same or substantially similar as described above.

In operation 206, a weighted cost of drivable routes may be calculated. The weighted cost may be used to efficiently create a ridesharing route while taking less time and resources. The weighted cost may be a numerical representation of the cost of various paths between geographical user inputs. The ridesharing route may then be created based upon the weighted cost of various paths between the geographical user inputs. For example, paths from the first starting point to the first destination point, second starting point, and second destination may all have specific weighted costs.

The weighted cost may be determined based on a drivable route between each of the geographical user inputs, or based on other types of routes between the geographical user inputs. In an embodiment, the weighted cost may be based on an estimated travel time between each of the geographical user inputs. The weighted cost may also be based on the distance between the geographical user inputs. In another embodiment, the weighted cost may be based on the destination and the arrival window of a user. The weighted cost is based upon factors such as road condition, traffic, weather, speed limits, and estimated travel time. The weighted cost may also be based on the prorated financial cost of travel between each of the geographical user inputs. The weighted cost may also include other factors such as preferences inputs. In an embodiment, the weighted cost may include smoking/nonsmoking preferences, insurance information, accident and traffic history of the driver, or other preferences.

In operation 128, the ridesharing route may be determined. The ridesharing route may be determined which paths from an origin to a destination, where the route reaches each geographical user input. The origin and destination may be selected based upon which user is driving. The origin and destination may also be selected based on the user's destination and arrival window. In an embodiment where no user is driving but a third party driver such as a taxi is shared, the origin may be at the user having the earliest departure window. The origin and destination may each be geographical user inputs. In an embodiment, the ridesharing route may a path based on the weighted cost. The ridesharing route may be a path from the origin to each geographical user input not yet reached which has the least weighted cost from the previous geographical user input. For example, in an embodiment where the weighted cost is based on estimated travel time, the ridesharing route would route from the origin to the geographical user input which is closest in terms of travel time. From that point, the route would continue to the next geographical user input, ignoring the geographical user inputs already reached, which is closest in terms of travel time. The route would continue in this manner until all of the geographical user inputs have been reached. However, various other methods of determining a ridesharing route using the weighted cost may be implemented to the same or similar effect.

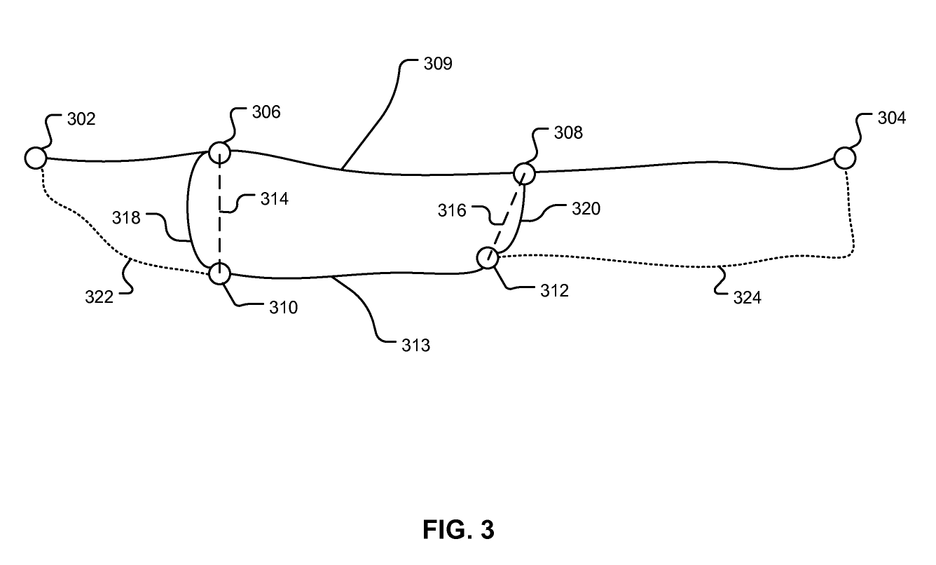

Referring now to FIG. 3, an embodiment of a first and second compatibility route having linking connections and having a ridesharing route may be seen. Geographic user inputs including a first starting point 302, first destination point 304, second starting point 310, and second destination point 312 may be seen. The geographic inputs may be the same or substantially similar as described above. The first starting point 302 and the first destination point 304 may correlate to the origin and the destination of a first user. The second starting point 310 and the second destination point 312 may correlate to the origin and the destination of a second user. A first compatibility route 309 for the first user may be seen connecting the first starting point 302 and the first destination point 304, where the first compatibility route is a drivable path. A second compatibility route 313 for the second user may be seen connecting the second starting point 310 and the second destination point 312. The compatibility routes may be the same or substantially similar as described above.

A first linking connection 314, 318 may link the first compatibility route 309 and the second compatibility route 313 from a first linking point 306 to the second starting point 310. The first linking connection 314, 318 may be a straight line 314. Alternatively, the first linking connection 314, 318 may be a drivable route 318. A second linking connection 316, 320 may link the first compatibility route 309 and the second compatibility route 313 from a third linking point 3086 on the first compatibility route 309 to the second destination point 312. However the first and second linking connections may link the compatibility routes at various other points. The second linking connection 316, 320 may be a straight line 316. Alternatively, the second linking connection 316, 320 may be a drivable route 320. The linking connections may be the same or substantially similar as described above. In an embodiment the first and second linking connections 314, 316, 318, 320 may be used to calculate a linking distance, described above, and may be compared to a preferred cost to indicate whether the first compatibility route 309, the second compatibility route 313, and the respective geographic user inputs 302, 304, 310, 312 are sufficiently similar to be trip compatible for a ridesharing route.

A ridesharing route 322, 313, 324, may link the first starting point 302 to the second starting point 310 to the second destination point 312 and to the first destination point 304. The ridesharing route 322, 313, 324, may be based on a weighted cost between each of the geographical user inputs. The rideshare route 322, 313, 324 may reach each geographical user input having the least weighted cost from the previous geographical user input which has not already been reached. In FIG. 3, the weighted cost may be based on the estimated travel time between geographic user inputs where the first starting point is the origin. Starting from the first starting point 302 the second starting point 310 may be the closest geographic user input by travel time. Thus, the route may have a first path 322 from the first starting point 302 to the second starting point 310. From the second starting point, the nearest point by travel time which has not yet been reached may be the second destination point. Thus, the route may have a second path 313 from the second starting point 310 to the second destination point 312. From the second destination point, the only geographic user input not yet reached is the first destination point 304. Thus, the route may have and a third path 324 from the second destination point to the first destination point.

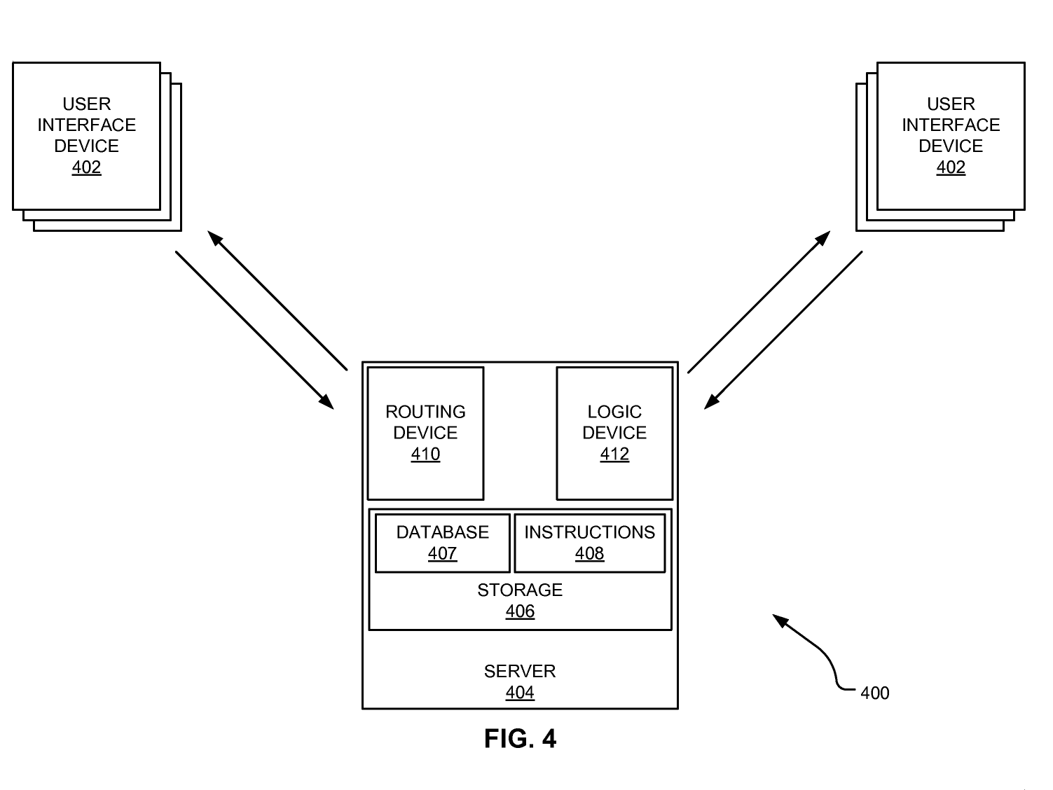

Referring now to FIG. 4 a ridesharing system 400 may be seen. The ridesharing system 400 may include user interface devices 402, a server 404 including, storage 406 having a database 407 and instructions 408, a routing device 410, and a logic module 412. All of these components may be communicatively coupled, directly or indirectly, for inter-component communication via various connections including wired connections, via buses, wirelessly, or by other type of connection.

The user interface devices 402 may support communication with a variety of storage 406 and user interface devices 402. For example, the ridesharing system may support the connection of one or more user interface devices 402, which may include user output devices (such as a video display device, speaker, or television set) and user input devices (such as a keyboard, mouse, keypad, touchpad, trackball, buttons, light pen, or other pointing device). A user may manipulate the user input devices utilizing a user interface, in order to provide input data and commands to the user interface device 402, the server 404, and other elements of the ridesharing system 400, and may receive output data via the user output devices. For example, a user interface may be presented via the user interface device 402, such as displayed on a display device, played via a speaker, or printed via a printer. The route requirements may be the same or substantially similar as the route requirements described above and may include geographical user inputs of a first starting point, a first destination point, a second starting point, and a second destination point. The database may be configured to store the route requirements from the two or more users.

The server 404, may contain elements of the ridesharing system 400 including the including, storage 406, the routing device 410, and the logic module 412. However in various embodiments additional elements may also be included within the server 404. In other embodiments elements of the ridesharing system may not be contained within the server 404. The sever 404 may function within a typical server-client architecture and may respond to requests across a network to assist in ridesharing determinations. In various embodiments a ridesharing system 400 that operates as a server 404 in one environment may operate as a client computer in another environment, and vice versa. The mechanisms and apparatus of embodiments of the present disclosure apply equally to other appropriate computing systems, including those which do not operate using a client-server architecture.

The storage 406 may include a random-access semiconductor memory, storage device, or storage medium (either volatile or non-volatile) for storing or encoding data and programs. In an embodiment, the storage 406 may represent the entire virtual memory of the ridesharing system 400, and may also include the virtual memory of other systems or devices coupled to the computer system 400. In an embodiment, the storage 406 may act as the virtual memory of the user interface devices 402. The storage 406 may be conceptually a single monolithic entity, but in other embodiments the storage 406 may be a more complex arrangement, such as a hierarchy of caches and other memory devices.

The storage 406 may store data 407, instructions 408, and other types of information, hereafter collectively referred to as “memory elements.” Although the memory elements are illustrated as being contained within the storage 406 in the server 404, in other embodiments some or all of them may be on different computer systems and may be accessed remotely, e.g., via a network. In an embodiment some or all of the memory elements may be contained within the user interface devices 402. The ridesharing system 400 may use virtual addressing mechanisms that allow the programs of the ridesharing system 400 to behave as if they only have access to a large, single storage entity instead of access to multiple, smaller storage entities. Thus, while the memory elements are illustrated as being contained within the storage 406, these elements are not necessarily completely contained in the same storage device at the same time. Further, although the memory elements are illustrated as being separate entities, in other embodiments some of them, portions of some of them, or all of them may be packaged together.

In an embodiment, the instructions 408 may be instructions or statements that execute in the logic device 412 or instructions or statements that may be interpreted by instructions or statements that execute in the logic device 412, to carry out the functions as described above with reference to the figures discussed above. In an embodiment, the instructions may include receiving route requirements from the database 407, determining a first compatibility route and a second compatibility route based on the geographic user inputs, determining a first linking connection from the first compatibility route to the second compatibility route, calculating a linking distance of the first linking connection, and determining a ridesharing route in response to the linking distance being less than or equal to a preferred linking distance.

In another embodiment, the memory elements, or two or more of these elements may be implemented in hardware via semiconductor devices, chips, logical gates, circuits, circuit cards, other physical hardware devices, or a combination of these devices in lieu of, or in addition to, a processor-based system. In an embodiment, the memory elements, or two or more of these elements may include data in addition to instructions or statements.

The routing device 410 may be configured to receive route requirements from the database 407 and may be configured to calculate drivable routes based upon route requirements. The routing device 410 may be a geographic system including global positioning satellite (GPS) systems, geographic information systems (GIS), or other types of geographic systems which may integrate, store, edit, analyze, share, and display geographic information for informing decision making. The geographic system may allow users to create user defined searches, analyze spatial information, edit data in maps, and present the results of these operations to users. In an embodiment, the routing device 410 may create a first compatibility route and a second compatibility route from the geographic user inputs. The first and second compatibility routes may be the same or substantially similar as described above. The routing device 410 may also be configured to calculate a first and second linking connection. The first and second linking connections may be the same or substantially similar as described above.

The first and second compatibility routes may be the same or substantially similar as described above. The routing device 410 may also be configured to create a ridesharing route reaching each of the geographical user inputs on command. The logic device 412 may be configured to use the first, second, and third linking points to determine a linking distance of the first and second linking connections, and configured to command the routing device to determine the ridesharing route if the linking distance is less than or equal to a preferred linking distance. The linking distance may be determined at least by an estimated travel time of the first and second linking connections.

The ridesharing system 400 may contain a logic device 412. The logic device 412 may include one or more general-purpose programmable central processing units (CPUs). In an embodiment, the ridesharing system 400 may contain multiple logic devices 412 typical of a relatively large system; however, in another embodiment the ridesharing system 400 may alternatively be a single CPU system. The logic device 412 may execute instructions 408 stored in the storage 406 and may include one or more levels of on-board cache.

As will be appreciated by one skilled in the art, aspects of the present invention may be embodied as a system, method, and computer program product or computer program. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). Java and all Java-based trademarks and logos are trademarks or registered trademarks of Oracle and/or its affiliates.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

For the avoidance of doubt, the term “comprising”, as used herein throughout the description and claims is not to be construed as meaning “consisting only of”.

The foregoing description of exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined in view of what would be apparent to those skilled in the art from the description provided herein and the claims appended hereto.

We claim:

1. A system for creating routes based on compatibility determinations comprising:
a user interface device configured to receive route requirements from a plurality of users, the route requirements for each of the plurality of users including a starting point, a destination point, a driver or rider preference, an arrival window, a destination window, and a fee rate, and the user interface device configured to present information to the plurality of users;
storage configured to store the route requirements;
a routing device configured to receive the route requirements from the storage and to determine to determine a ridesharing route on command; and
a logic device configured to determine whether the route requirements are trip compatible, and configured to command the routing device to determine the ridesharing route in response to the determining that the route requirements are trip compatible.

2. The system of claim 1, wherein the logic device is configured to;
determine a first compatibility route and a second compatibility route based on the starting point and the destination point for the first and second users;
determine a first linking connection from the first compatibility route to the second compatibility route;
calculate a linking distance of the first linking connection; and
determine the route requirements are trip compatible in response to the linking distance being less than or equal to a preferred linking distance.

3. The system of claim 2, wherein the logic device is configured to;
determine whether the departure window for the first and second user overlap and determining whether the arrival window for the first and second user overlap; and
determine the route requirements are trip compatible in response to determining that the departure windows overlap and that the arrival windows overlap.

4. The system of claim 3, wherein the logic device is configured to
determine at least one driver and at least one rider based on the driver or rider preference;
determine the route requirements are trip compatible in response to the fee rate for the at least one driver being less than or equal to the fee rate for the at least one rider.
determine a ridesharing cost of the ridesharing route; and
wherein the user interface device is configured to present the ridesharing cost to the plurality of users and receive acceptance of the ridesharing route from the at least one driver and the at least one rider.
